(19) United States
(12) Patent Application Publication
(10) Pub. No.: US 2006/0162124 A1
(43) Pub. Date: Jul. 27, 2006

(54) Glass door hinge structure

(76) Inventor: Ching-Yi Lin, Hemei Township (TW)

Correspondence Address: RABIN & BERDO, P.C., 1101 14th Street, N.W., Suite 500, Washington, DC, 20005, US

(21) Appl. No.: 11/041,280

(22) Filed: Jan. 25, 2005

(51) Int. Cl. E05D 5/02

(52) U.S. Cl. 16/252

(57) ABSTRACT

A glass door hinge structure in which the hinge body consists of an inner protruding section with perpendicular corners fabricated along the periphery and, furthermore, a recess is disposed in one side of the protruding section and the outer surface is a level plane. As a result, mounting at the corresponding position on the glass door only requires an identically shaped hole that accommodates the projecting section. Additionally, the hinge cover plate is fabricated as a planar surface because the protruding section outer surface is a level plane, thereby saving material, streamlining the fabrication process, reducing cost, as well as lowering friction and scraping against the hinge cover plate to maintain an attractive appearance free of superficial scratches.

### BACKGROUND OF THE INVENTION

1) Field of the Invention

The invention herein relates to a glass door hinge structure in which the said hinge body consists of an inner protruding section with perpendicular corners fabricated along the periphery and, furthermore, a recess is disposed in one side of the protruding section and the outer surface is a level plane. As a result, mounting at the corresponding position on a glass door only requires an identically shaped hole that accommodates the said projecting section. Additionally, the hinge cover plate is fabricated as a planar surface, thereby saving material, streamlining the fabrication process, reducing cost, as well as lowering friction and scraping against the said hinge cover plate to maintain an attractive appearance free of superficial scratches.

2) Description of the Prior Art

A conventional glass door-use hinge installation, as indicated in FIG. 1, FIG. 2-A, FIG. 2-B, and FIG. 2-C, consists of a plurality of elastic cushion pads B that are attached to both the inner and outer sides of a glass door A, following which the hinge bodies C and the hinge cover plates D are respectively mounted to both the inner and the outer sides of the glass door A, with the hinge bodies C, the hinge cover plates D, and the elastic cushion pads B then tightly fastened by means of screws E. However, during installation it has been found that to allow for fastening the currently available hinge bodies C with screws E, extending arcuate sections C1 are formed at four corners, following which threads C2 are tapped in the arcuate sections C1; in such a design, all the elastic cushion pads B must be formed with identically shaped gaps B1 and, furthermore, the glass door A also requires the particular shape of the opening A1 before installation is possible, an aspect that results in significantly increased production cost and, furthermore, also increases fabrication difficulty in that if the small arcs A2 in the space of the glass door A opening A1 space are not skillfully cut, the entire component is discarded; the same problem occurs with the hinge body C and, furthermore, due to the prominence C3 at the protruding section on the outer surface of the hinge body C, packaging requires exceptional protective care as scratching renders it a defective product; additionally, since the protruding section on the outer surface of the hinge body consists of a prominence C3, an opening D1 must be cut at a corresponding position in each hinge cover plate D to enable hinge cover plate D installation, resulting in a difficult fabrication procedure and additional production cost. As such, the prior art is troublesome to manufacturers and awaits improvement.

### SUMMARY OF THE INVENTION

As a result, the applicant of the invention herein developed the present invention which is submitted as a patent application.

The primary objective of the invention herein is to provide a glass door hinge structure in which the said hinge body consists of an inner protruding section with perpendicular corners fabricated along the periphery and, furthermore, a recess is disposed in one side of the protruding section and the outer surface is a level plane; as a result, mounting at the corresponding position on the glass door only requires an identically shaped hole that accommodates the said projecting section; and the hinge cover plate is fabricated as a planar surface because the protruding section outer surface is a level plane, thereby saving material, streamlining the fabrication process, reducing cost, as well as lowering friction and scraping against the said hinge cover plate to maintain an attractive appearance free of superficial scratches.

### BRIEF DESCRIPTION OF THE DRAWINGS

FIG. 1 is an isometric drawing of a conventional glass door hinge installation.

FIG. 2-A is an isometric drawing of the prior art structure, as viewed from the front.

FIG. 2-B is an isometric drawing of the prior art structure, as viewed from the rear.

FIG. 2-C is an exploded drawing of the prior art structural assembly.

FIG. 3-A is an isometric drawing of the structure of the invention herein, as viewed from the front.

FIG. 3-B is an isometric drawing of the structure of the invention herein, as viewed from the rear.

FIG. 4 is an exploded drawing of the assembly of the invention herein.

### DETAILED DESCRIPTION OF THE PREFERRED EMBODIMENTS

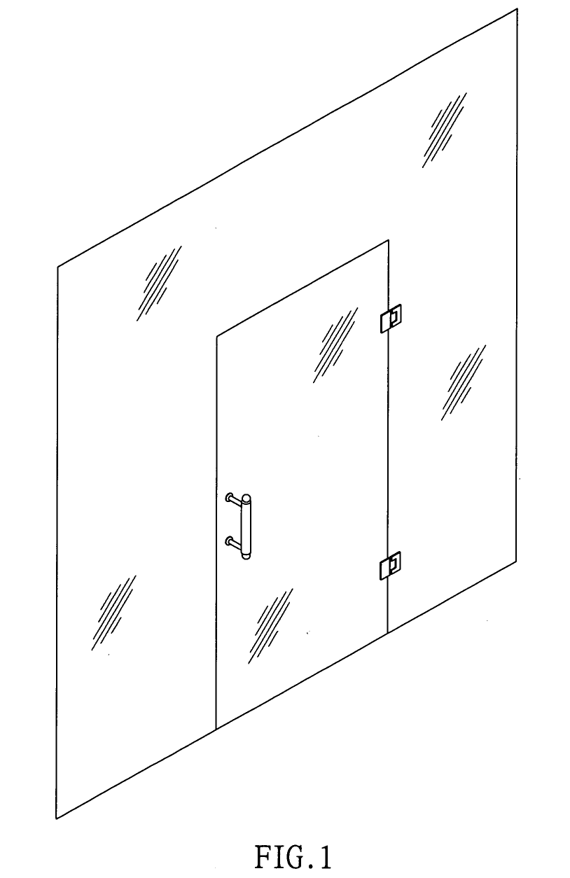

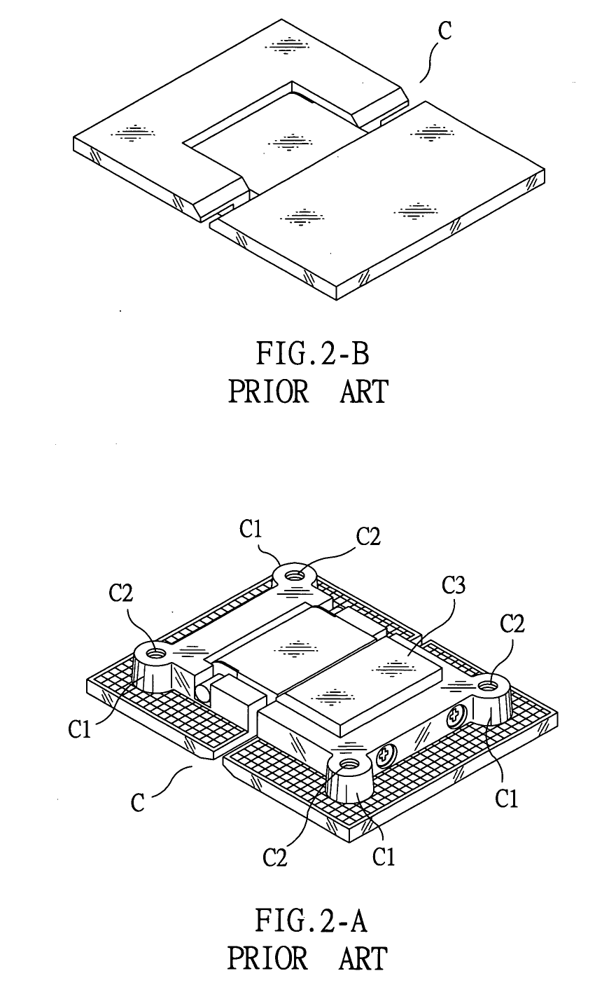

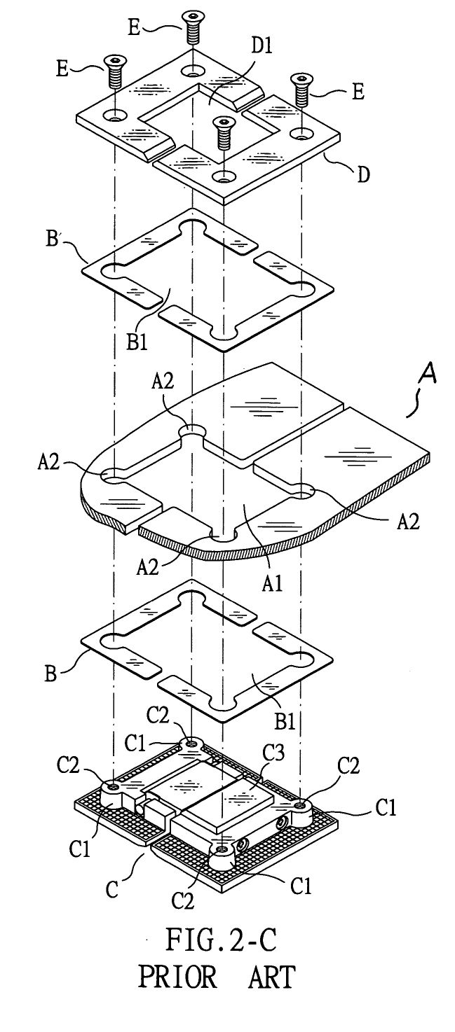

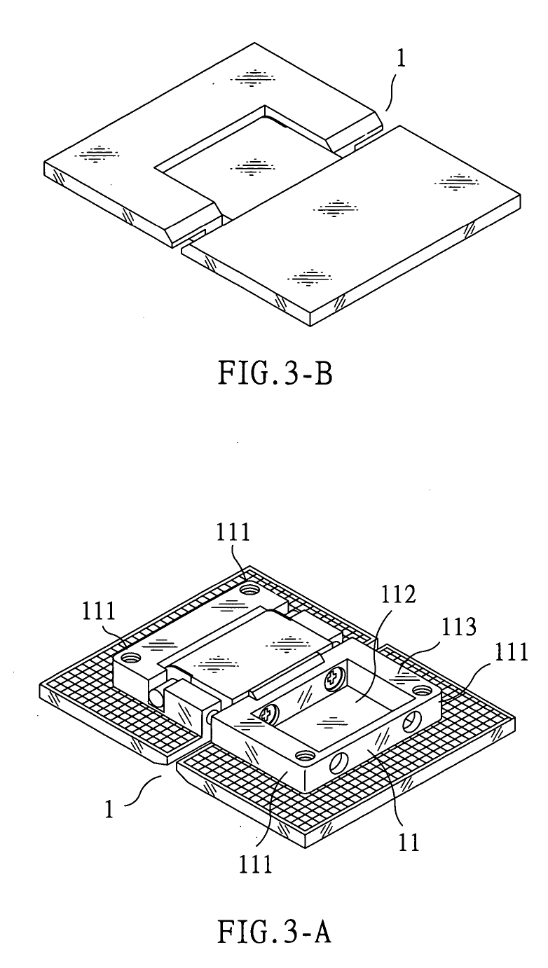

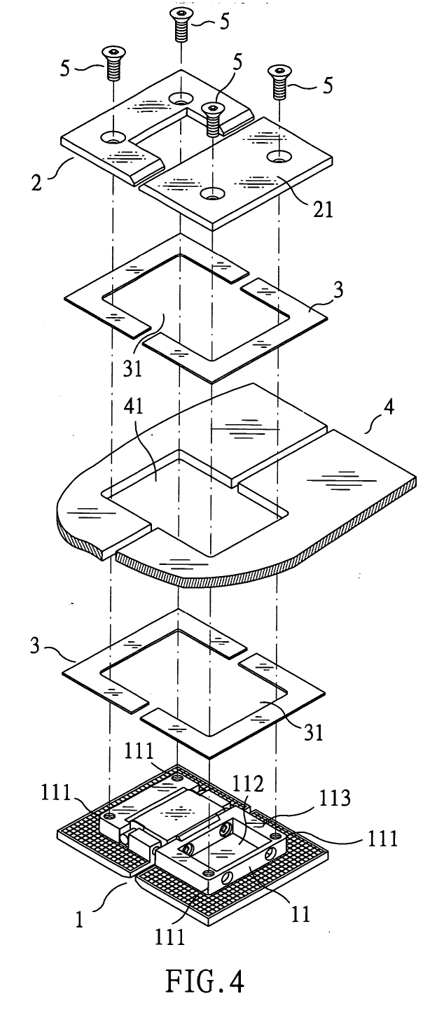

Referring to FIG. 1, FIG. 2-A, FIG. 3-B, and FIG. 4, the glass door hinge structure of the invention herein is installed at the both top and bottom positions along one side of a glass door 4, thereby providing for the forward pushing or rearward pulling open of the said glass door 4, wherein the said hinge body 1 consists of an inner protruding section 11 with perpendicular corners 111 fabricated along the periphery and, furthermore, a recess 112 is disposed in one side of the protruding section 11 and the outer surface is a level plane 113; the recess 112 fabricated in the protruding section 11 does not affect operation, but reduces the overall weight of the hinge body 1 and saves material, while also streamlining production and eliminating wear during molding operations; additionally, the hinge body 1 protruding section 11 outer surface is a level plane 113 and, as a result, the overlaid hinge cover plate 2 surface section is fabricated as a planar surface 21, precluding the troublesome necessity of cutting the opening D1 as is the case for the prior art; and since the said hinge body 1 projecting section 11 consists of perpendicular corners 111 fabricated along its periphery, mounting at the corresponding position on the glass door 4 only requires the forming of an identically shaped hole 41 that matches the periphery of the said projecting section 11, thereby considerably streamlining the fabrication process, since the openings A1 in the prior art glass door A still require the machining of the small arcs A2 ,and lowering the wastage of mechanical efficiency; additionally, the elastic cushion pad 3 gaps 31 only require fabrication such that they match the perpendicular corners 111 along the periphery of the hinge body 1 protruding section 11.

As such, a plurality of elastic cushion pads 3 are attached to both the inner and outer sides of the glass door 4, following which the hinge bodies 1 and the hinge cover plates 2 are respectively mounted to both the inner and the outer sides of the glass door 4, and then the hinge bodies 1, the hinge cover plates 2, and the elastic cushion pads 3 are tightly fastened by means of screws 5.

Therefore, the invention herein not only lightens the weight of the hinge body 1, but at the same time saves production materials, streamlines the fabrication process, reduces cost, and furthermore, lowers hinge cover plate 2 friction and scraping, thereby maintaining an attractive appearance free of superficial scratches; as such, since the invention herein is demonstrably progressive and meets the application requirements stipulated in Article 93 of the Patent Law, the present invention is submitted to the patent bureau for review and the granting of the commensurate patent rights.

1. (canceled)

2. A glass door hinge structure, comprising:
a hinge body that is disposable on one side of a glass door, and having an inner, rectangular-shaped protruding section that is projectable through an opening formed in the glass door, the protruding section being defined by four linear sides that are free of arcuate sections, the protruding section having four right-angle corners, an upper surface of the protruding section being flat, and being completely disposed in a level plane, a recess being formed in one side of the protruding section, the recess being surrounded by the upper surface, a plurality of fastener holes being formed in the upper surface; and
a hinge cover plate that is disposable on another side of the glass door, and being fastenable to said hinge body, and having a planar surface that faces said hinge body, and having a plurality of through holes formed therein, the through holes being in registration with the fastener holes in said hinge body.

3. The glass door hinge structure recited in claim 2, further comprising at least one elastic cushion pad disposed between said hinge body and said hinge cover plate, when said hinge cover plate is fastened to said hinge body.

4. The glass door hinge structure recited in claim 3, wherein said hinge cover plate is fastened to said hinge body using screws that extend through the through holes formed in said hinge cover plate and which engage with the fastener holes formed in the upper surface of said hinge body.

5. In combination,
a glass door having two abutting sections, and having a opening that has a rectangular shape defined in abutting edges of the two sections;
a hinge body disposed on one side of the glass door, and having an inner, rectangular-shaped protruding section that fits within the opening in said glass door, the protruding section being defined by four linear sides that are free of arcuate sections, and having four right-angle corners, an upper surface of the protruding section being flat, and being completely disposed in a level plane, a recess being formed in one side of the protruding section, the recess being surrounded by the upper surface, a plurality of fastener holes being formed in the upper surface; and
a hinge cover plate disposed on another side of the glass door, and being fastenable to said hinge body, and having a planar surface that faces said hinge body, and having a plurality of through holes formed therein, the through holes being in registration with the fastener holes in said hinge body.
